(19) United States
(12) Patent Application Publication
(10) Pub. No.: US 2017/0067128 A1
(43) Pub. Date: Mar. 9, 2017

(54) CONVERTER SLAGGING MONITORING METHOD AND SYSTEM

(71) Applicant: HUNAN RAMON SCIENCE & TECHNOLOGY CO., LTD., Changsha, Hunan (CN)

(72) Inventors: Lu TIAN, Changsha, Hunan (CN); Taotao HE, Changsha, Hunan (CN)

(73) Assignee: HUNAN RAMON SCIENCE & TECHNOLOGY CO., LTD., Changsha, Hunan (CN)

(21) Appl. No.: 15/120,486

(22) PCT Filed: Oct. 20, 2014
(86) PCT No.: PCT/CN2014/088918

§ 371 Date: Aug. 19, 2016

(30) Foreign Application Priority Data
Jul. 30, 2014 (CN) 201410369416.0

(51) Int. Cl. C21C 5/46; G01B 21/08

(52) U.S. Cl. CPC C21C 5/4673; G01B 21/085

(57) ABSTRACT

A converter slagging monitoring method and device. The method comprises: acquiring converter smelting data containing converter noise data and oxygen lance vibration data in real time; based on a pre-established slagging monitoring model, calculating the thickness of slags in a converter molten bath by virtue of the acquired converter smelting data; comparing the calculated thickness of slags with a splashing threshold value and a drying threshold value which are contained in the slagging monitoring model, judging whether a comparison result characterizes the occurrence of splashing or drying, and when the comparison result characterizes the occurrence of splashing or drying, acquiring corresponding splashing information or drying information; and finally, according to the splashing information or drying information, making a corresponding splashing control scheme or drying control scheme to guide a subsequent slagging operation so as to achieve the smooth control of the lance position.

This application claims priority to Chinese Patent Application No. 201410369416.0, titled “CONVERTER SLAGGING MONITORING METHOD AND SYSTEM”, filed with the Chinese State Intellectual Property Office on Jul. 30, 2014, which is incorporated by reference in its entirety herein.

### FIELD

The present disclosure relates to the field of converter steelmaking technologies, and in particular to method and system for monitoring converter slagging.

### BACKGROUND

Slagging is a key process in converter steelmaking, steel quality and steelmaking efficiency directly affected by stability of the slagging process. And a serious waste of raw material and an accident such as personal casualties and equipment damages may be caused, in a case that splashing or drying occurs during the slagging process.

In order to ensure steady slagging, the slagging process is monitored. Conventionally, the slagging is monitored manually. That is, in the slagging process, a converter operator determines a slagging state in a molten bath by monitoring a slagging noise and observing flame in a converter mouth, and ensures the stability of the slagging by control means such as adjusting height of an oxygen lance, to avoid occurrence of the splashing or the drying. However, the manual monitoring is limited by factors such as experiences and proficiency, thereby reducing stability and accuracy of a monitoring result and not facilitating the control for the steady slagging.

### SUMMARY

In view of the above, the present disclosure provides method and system for monitoring converter slagging to overcome the above issue, thereby improving stability and accuracy of monitoring a slagging state and further ensuring steady slagging to a high extent.

In order to address the above issue, it is provided a method for monitoring converter slagging according to the present disclosure. The method includes:
acquiring converter smelting data in a real time manner, where the converter smelting data includes slagging noise data and oxygen lance vibration data;
calculating slag thickness of a converter molten bath from the slagging noise data and the oxygen lance vibration data based on a pre-established converter slagging monitoring model, where the converter slagging monitoring model includes an association relationship between the slag thickness of the converter molten bath, a slagging noise sound intensity feature and an oxygen lance vibration feature, and the converter slagging monitoring model further includes a splashing threshold value and a drying threshold value as evaluation references for the slag thickness;
comparing the calculated slag thickness with the splashing threshold value and the drying threshold value to obtain a comparison result;
determining whether the comparison result indicates that splashing or drying will occur, and acquiring splashing information corresponding to the splashing or drying information corresponding to the drying in a case that the comparison result indicates that the splashing or the drying will occur; and
formulating a splashing control scheme based on the splashing information or a drying control scheme based on the drying information, to guide subsequent control for steady slagging.

Based on the above method, preferably, the slagging noise data may include an intensity of a slagging noise and a frequency band to which the slagging noise belongs, the oxygen lance vibration data may include a frequency of oxygen lance vibration and an intensity of the oxygen lance vibration.

Based on the above method, preferably, the method may further include: performing a splashing early warning corresponding to the splashing or a drying early warning corresponding to the drying in a case that the comparison result indicates that the splashing or the drying will occur.

Based on the above method, preferably, the converter smelting data may further include converter mouth flame image data.

Based on the above method, preferably, the method may further include: calibrating the splashing threshold value in the converter slagging monitoring model with the converter mouth flame image data.

Based on the above method, preferably, the converter slagging monitoring model may further include an association relationship between process parameter data during converter smelting and the slag thickness, the process parameter data may include charging data, oxygen lance operation data, an amount of blown oxygen and an iron melt component.

A device for monitoring converter slagging includes a smelting data acquisition module, a slag thickness acquisition module, a comparison module, a determination module and a control scheme formulation module, where
the smelting data acquisition module is configured to acquire converter smelting data in a real time manner, and the converter smelting data includes slagging noise data and oxygen lance vibration data;
the slag thickness calculation module is configured to calculate slag thickness of a converter molten bath from the slagging noise data and the oxygen lance vibration data based on a pre-established converter slagging monitoring model, the converter slagging monitoring model includes an association relationship between the slag thickness of the converter molten bath, a slagging noise sound intensity feature and an oxygen lance vibration feature, and the converter slagging monitoring model further includes a splashing threshold value and a drying threshold value as evaluation references for the slag thickness;
the comparison module is configured to compare the calculated slag thickness with the splashing threshold value and the drying threshold value to obtain a comparison result;
the determination module is configured to determine whether the comparison result indicates that splashing or drying will occur, and acquire splashing information corresponding to the splashing or drying information corresponding to the drying in a case that the comparison result indicates that the splashing or the drying will occur; and
the control scheme formulation module is configured to formulate a splashing control scheme based on the splashing information or a drying control scheme based on the drying information, to guide subsequent control for steady slagging.

Based on the above device, preferably, the device may further include:
an early warning module configured to perform a splashing early warning corresponding to the splashing or a drying early warning corresponding to the drying in a case that the comparison result indicates that the splashing or the drying will occur.

Based on the above device, preferably, the device may further include:
a model calibration module configured to calibrate the splashing threshold value in the converter slagging monitoring model with acquired converter mouth flame image data.

In summary, the method and system for monitoring converter slagging are provided according to the present disclosure. In the method, the converter smelting data including the converter noise data and the oxygen lance vibration data is acquired in a real time manner. The slag thickness of the converter molten bath is calculated from the acquired converter smelting data based on the pre-established converter slagging monitoring model. The calculated slag thickness is compared with the splashing threshold value and the drying threshold value in the converter slagging monitoring model. It is determined whether the comparison result indicates that the splashing or the drying will occur, the splashing information corresponding to the splashing or the drying information corresponding to the drying is acquired in a case that the comparison result indicates that the splashing or the drying will occur. Finally, the splashing control scheme is formulated based on the splashing information or the drying control scheme is formulated based on the drying information to guide subsequent slagging operations, thereby controlling a lance location steadily.

It can be seen that, in the present disclosure, it is avoided a defect that manual monitoring is limited by factors such as experiences and proficiency, thereby improving the stability and accuracy of the slagging state detection, and thus ensuring steady slagging to a high extent.

### BRIEF DESCRIPTION OF THE DRAWINGS

FIG. 1 is a flowchart of a method for monitoring converter slagging according to a first embodiment of the present disclosure;

FIG. 2(a) is a sound intensity curve of a steady smelting process according to the first embodiment of the present disclosure;

FIG. 2(b) is a sound intensity curve of a smelting process in which splashing occurs according to the first embodiment of the present disclosure;

FIG. 2(c) is a sound intensity curve of a smelting process in which drying occurs according to the first embodiment of the present disclosure;

FIG. 3(a) is a vibration intensity curve of the smelting process in which the splashing occurs according to the first embodiment of the present disclosure;

FIG. 3(b) is a vibration intensity curve of the smelting process in which the drying occurs according to the first embodiment of the present disclosure;

FIG. 4 is a flowchart of a method for monitoring converter slagging according to a second embodiment of the present disclosure;

FIG. 5 is a flowchart of a method for monitoring converter slagging according to a third embodiment of the present disclosure;

FIG. 6(a) is a flame brightness feature curve of a steady converting process according to the third embodiment of the present disclosure;

FIG. 6(b) is a flame brightness feature curve of a converting process in which splashing occurs according to the third embodiment of the present disclosure;

FIG. 7 is a schematic structural diagram of a device for monitoring converter slagging according to a fifth embodiment of the present disclosure;

FIG. 8 is another schematic structural diagram of the device for monitoring converter slagging according to the fifth embodiment of the present disclosure;

FIG. 9 is yet another schematic structural diagram of the device for monitoring converter slagging according to the fifth embodiment of the present disclosure;

FIG. 10 is an assembly diagram of components of a system for monitoring slagging according to the fifth embodiment of the present disclosure; and

FIG. 11 is a diagram illustrating a drawing example of a slag thickness curve of a molten bath according to the fifth embodiment of the present disclosure.

### DETAILED DESCRIPTION

In the following, preferred embodiments of the present disclosure are described to make the present disclosure further be understood. It should be understood that, these descriptions are only used to further illustrate features and advantages of the present disclosure, and are not intended to limit the claims of the present disclosure.

### First Embodiment

A method for monitoring converter slagging is provided according to the first embodiment, the method is described in the following.

In a converter, a slagging noise with a high intensity may be generated in a converting process. For example, in the converter, a supersonic oxygen stream and unmelted slag each may cause strong noises. The intensity of such noise reaches a maximum in a case of beginning to convert and serious drying (that is, no covering liquid slag). In a case that foamed slag is formed, the noise caused by the oxygen stream is absorbed by the foamed slag over an oxygen lance nozzle. The thicker a slag layer is, the greater the height of the foamed slag for absorbing the noise is, and thus the lower the intensity of the noise from the converter is. Therefore, the intensity of the slagging noise in the converting of the converter may indirectly reflect a slagging situation in the converter.

Moreover, in the converting process of the converter, the oxygen lance may generate vibration due to a counterforce from the oxygen stream blown from the oxygen lance, slag buoyancy and impact force caused by continuous rolling foamed slag. Force applied on the oxygen lance are different depending on different melting states of the slag. Therefore, a vibration frequency of the oxygen lance and vibration amplitude (i.e. intensity) of the oxygen lance may also reflect the slagging situation in the converter.

Based on the above, in the present disclosure, a converter slagging monitoring model is established in advance. The converter slagging monitoring model reflects an association relationship between an slagging noise intensity, an oxygen lance vibration intensity and a slag thickness in the converter. And the slag thickness in the converter is predicted based on the real-time slagging noise intensity and the oxygen lance vibration intensity.

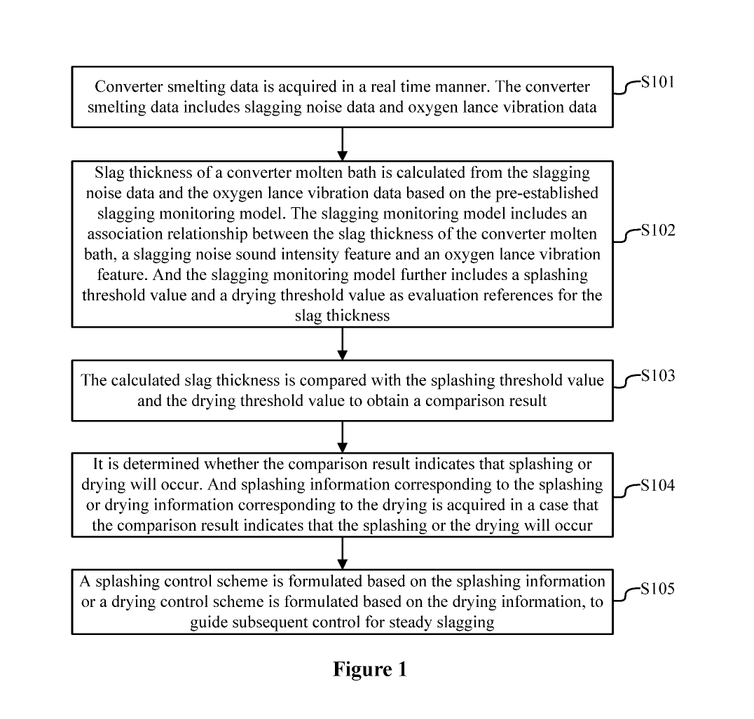

As shown in FIG. 1, the above method for monitoring converter slagging includes step S101 to step S105.

In step S101, converter smelting data is acquired in a real time manner. The converter smelting data includes slagging noise data and oxygen lance vibration data.

In the embodiment, a converter mouth noise signal acquisition module for acquiring a slagging noise signal and an oxygen lance vibration signal acquisition module for acquiring an oxygen lance vibration signal are arranged beforehand at corresponding locations of the converter. In this case, the slagging noise data and the oxygen lance vibration data are acquired respectively from the converter mouth noise signal acquisition module and the oxygen lance vibration signal acquisition module in a real time manner.

The slagging noise data includes the intensity of the slagging noise and a frequency band to which the slagging noise belongs. The oxygen lance vibration data includes a frequency of oxygen lance vibration and an intensity of the oxygen lance vibration.

In step S102, slag thickness of a converter molten bath is calculated from the slagging noise data and the oxygen lance vibration data based on the pre-established slagging monitoring model. The slagging monitoring model includes an association relationship between the slag thickness of the converter molten bath, a slagging noise sound intensity feature and an oxygen lance vibration feature. And the slagging monitoring model further includes a splashing threshold value and a drying threshold value as evaluation references for the slag thickness.

Specifically, the applicant of the present disclosure establishes the converter slagging monitoring model in advance, based on research on an association between audio features of multiple frequency bands of the slagging noise, the oxygen lance vibration feature and a slagging state. And then the slagging state of the converter is acquired in a real time manner by calculating the slag thickness of the converter molten bath with the model.

Firstly, an association between the slagging noise sound intensity feature and the slagging state is researched.

It can be seen from the research that, a frequency of a noise generated in a converting process is reduced with an increasing tonnage of a converter. At present, there are different converters with different tonnages in the market. Feature frequencies of the converters are generally in a range from 100 Hz to 500 Hz inclusively, and the frequency band to which the noise of each of the converters belongs may be changed due to change in converter age and converter lining of the converter. Therefore, the converter mouth noise signal acquisition module according to the embodiment may detect audio signals in multiple feature frequency bands simultaneously. In practice, the converter mouth noise signal acquisition module has to choose one frequency band of which a monitoring effect is better (reflecting the slagging state better), from multiple frequency bands in which the converter mouth noise signal acquisition module can perform detection, as a main detection frequency band. Subsequently, a sound intensity feature of the main detection frequency band has to be detected accurately, sound intensity features of two frequency bands adjacent to the main detection frequency band also have to be detected accurately, and sound intensity features of other frequency bands may be detected roughly.

In the embodiment, a main feature frequency band is chosen based on the smelting data of 300 heats. Average sound intensities of each of the frequency bands in three periods: beginning of smelting, middle of the smelting and ending of the smelting, are calculated. Two feature frequency bands, of each of which consistency of the average sound intensity is optimal (waving minimally), are chosen. Splashing features respectively represented by the sound intensities of the two feature frequency bands are compared with a splashing feature represented by a converter mouth image. And one of the two feature frequency bands, of which the splashing feature is most matched with the splashing feature represented by the converter mouth image, is chosen as the main detection frequency band. Since the frequency band to which the noise of the converter belongs may be changed due to change in the converter age and the converter lining of the converter, the main detection frequency band has to be replaced in time to ensure accuracy of the monitoring. For example, in a case that a sound intensity feature of an adjacent frequency band can reflect the slagging state more accurately, the adjacent frequency band serves as a new main detection frequency band by replacing the original main detection frequency band. Alternatively, the main detection frequency band may be re-chosen after the smelting is performed for a certain number of heats such as 2000 heats.

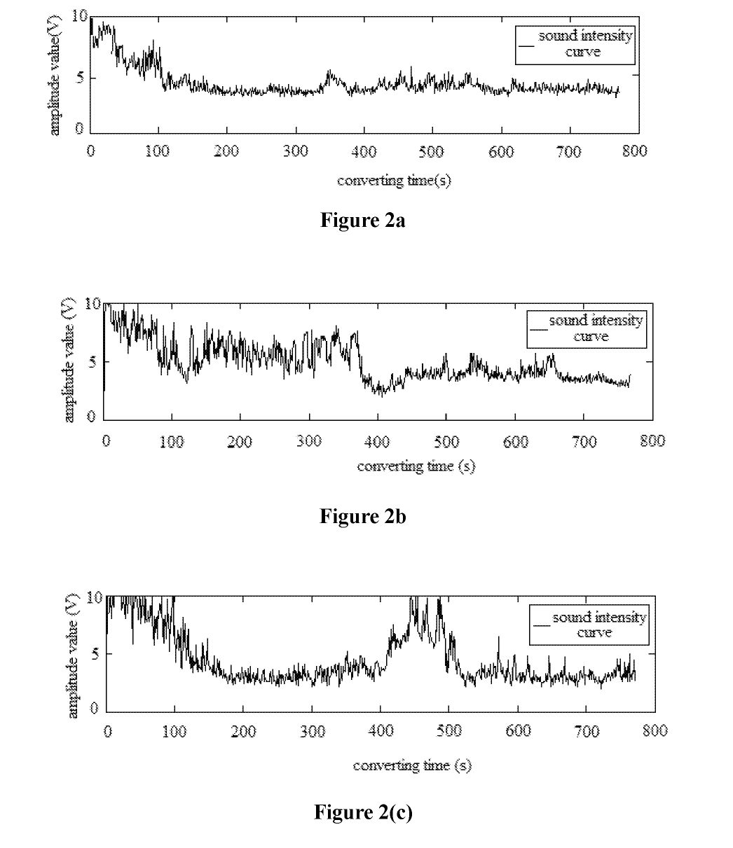

In a case that smelting in a converter is steady and slagging is good, a sound intensity curve of the smelting is steady without large fluctuation, as shown in FIG. 2(a). In the following, a sound intensity curve in a case that splashing occurs in a slagging process and a sound intensity curve in a case that drying occurs in a slagging process are researched by taking the sound intensity curve in a case of the steady smelting process in FIG. 2 (a) as the reference.

A heat with ID (Identity) 7 in which splashing begins at about 380 seconds is chosen, and a sound intensity curve in a case that the splashing occurs in a smelting-slagging process of the heat with ID 7 is analyzed by taking FIG. 2(a) as the reference. As shown in FIG. 2(b), the sound intensity curve begins to fall at about 360 seconds and reaches a minimal value at 400 seconds. Then, an oxygen lance operator controls a lance location. Hence the splashing is controlled, the sound intensity curve rises and an amplitude value of the sound intensity tends to be steady at about 3.8V.

A heat with ID 11 in which drying begins at about 430 seconds is chosen, and a sound intensity curve of a slagging process of the heat with ID 11 is shown in FIG. 2(c). The sound intensity begins to rise slowly at about 300 seconds, rises faster at 400 seconds and reaches a maximal value at 450 seconds. Then the oxygen lance operator controls the lance location. Hence the drying is controlled, the sound intensity curve falls and an amplitude value of the sound intensity tends to be steady at about 3.7V.

Next, an association between the oxygen lance vibration and the slagging state is researched.

In a converter smelting process with good slagging, a vibration curve of the oxygen lance is steady. In the embodiment, a vibration frequency f1 capable of representing splashing and a vibration frequency f2 capable of representing drying are chosen. And vibration feature curves in a case of the splashing and the drying are analyzed. The heat with ID 7 and the heat with ID 11 are also chosen to facilitate comparison with the sound intensity feature.

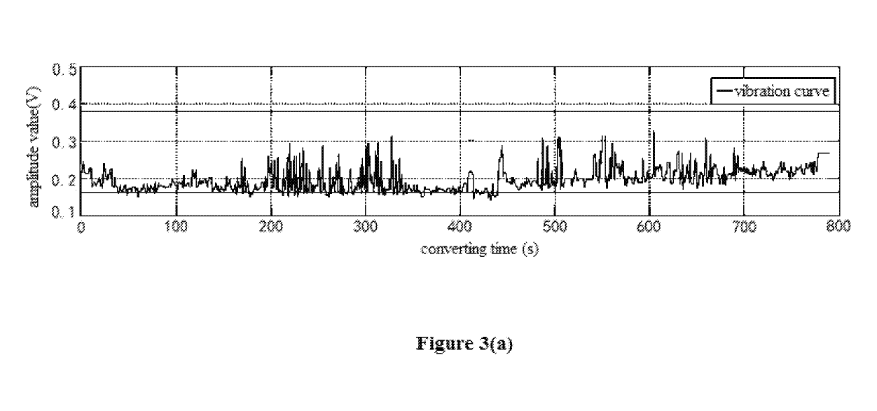

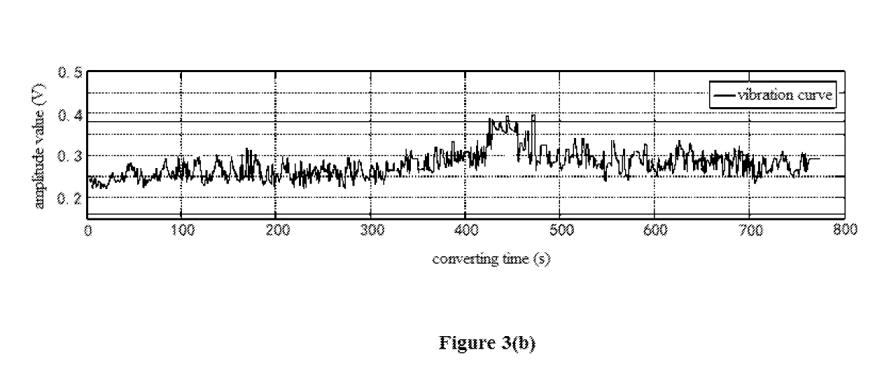

Reference is made to FIG. 3(a). FIG. 3(a) shows an oxygen lance vibration curve of the heat with ID 7 in which the splashing begins at about 380 seconds. It can be seen from FIG. 3(a) that, due to a rising slag level, the oxygen lance vibration is weakened and an amplitude value of the vibration curve begins to fall apparently at about 350 seconds. A change trend of the vibration feature is consistent with a change trend of the sound intensity feature shown in FIG. 2(b). And the vibration feature changes more apparently and more facilitates determination of the slagging state.

FIG. 3(b) shows an oxygen lance vibration curve of the heat with ID 11 in which the drying begins at about 430 seconds. It can be seen from FIG. 3(b) that, in a case that the slag level in the converter falls and the drying tends to occur, the oxygen lance vibration is strengthened and the amplitude value of the vibration curve begins to increase apparently at about 420 seconds, as shown in FIG. 3(b). A change trend of the vibration feature is consistent with a change trend of the sound intensity feature shown in FIG. 2(c), that is, the vibration intensity and the sound intensity each begin to rise slowly at about 300 seconds. And the sound intensity feature changes more apparently and more facilitates the determination of the slagging state.

Based on a large quantity of field tests, analysis and researches, it is found by the applicant that, in a case of the splashing, the vibration feature changes more apparently than the sound intensity feature, hence the splashing is predicted with the vibration feature more speedily than with the sound intensity feature. In a case of the drying, the sound intensity feature changes more apparently, hence the drying is predicted with the sound intensity feature more speedily than with the vibration feature. In order to improve prediction efficiency (the earlier a prediction time is than an actual occurring time, the higher the prediction efficiency is), the vibration feature is taken as a main impact factor for splashing prediction and the sound intensity feature is taken as a main impact factor for drying prediction, in the present disclosure.

Based on the above, in the embodiment, in order to represent different impact degrees on the splashing prediction and the drying prediction by different features, the converter slagging monitoring model is established by considering two cases: a splashing prediction case and a drying prediction case. In the splashing prediction case, a great weight is allocated for the oxygen lance vibration intensity while a small weight is allocated for the slagging noise intensity, and the oxygen lance vibration intensity is taken as a main impact factor for a slagging state prediction. In the drying prediction case, a small weight is allocated for the oxygen lance vibration intensity while a great weight is allocated for the slagging noise intensity, and the slagging noise intensity is taken as the main impact factor for the slagging state prediction.

In addition, the splashing threshold value and the drying threshold value which serve as evaluation references have to be set beforehand. In a case that the slag thickness reaches the splashing threshold value or the drying threshold value in a smelting process, it is indicated that the splashing or the drying will occur.

The objective of the present disclosure is to predict in advance and control the lance location before the splashing or drying actually occurs to make the slagging steady. Therefore, the set splashing threshold value has to be smaller than a critical slag thickness value under which the splashing actually occurs in the slagging process, and the set drying threshold value has to be greater than a critical slag thickness value under which the drying actually occurs in the slagging process. In the embodiment, the splashing threshold value and the drying threshold value are set as follows initially. The splashing threshold value equals to 80% of the critical slag thickness value under which the splashing actually occurs, and the drying threshold value equals to 120% of the critical slag thickness value under which the drying actually occurs.

The splashing threshold value and the drying threshold value can be set by those skilled in the art, based on a requirement of balance between the prediction efficiency and prediction accuracy for the slagging state.

Based on the pre-established converter slagging monitoring model, in step S102, the real-time slag thickness of the converter molten bath is calculated from the slagging noise data and the oxygen lance vibration data acquired in a real time manner.

In step S103, the calculated slag thickness is compared with the splashing threshold value and the drying threshold value to obtain a comparison result.

In step S104, it is determined whether the comparison result indicates that splashing or drying will occur. And splashing information corresponding to the splashing or drying information corresponding to the drying is acquired in a case that the comparison result indicates that the splashing or the drying will occur.

In a case that the calculated slag thickness is greater than or equal to the splashing threshold value, it is indicated that the splashing will occur. In a case that the calculated slag thickness is smaller than or equal to the drying threshold value, it is indicated that the drying will occur. And the slag thickness, the slagging noise data and the oxygen lance vibration data when the splashing or the drying occurs are taken as the splashing information or the drying information, based on which a control scheme is formulated subsequently.

In step S105, a splashing control scheme is formulated based on the splashing information or a drying control scheme is formulated based on the drying information, to guide subsequent control for steady slagging.

In step S105, the control scheme is formulated based on the slag thickness, the slagging noise data and the oxygen lance vibration data indicated by the acquired splashing information or drying information. It is determined how to control and adjust the lance location of the oxygen lance, to guide slagging operation effectively and control the lance location steadily.

In summary, in the method provided according to the present disclosure, the converter smelting data including the converter noise data and the oxygen lance vibration data is acquired in a real time manner. The slag thickness of the converter molten bath is calculated from the acquired converter smelting data based on the pre-established converter slagging monitoring model. The calculated slag thickness is compared with the splashing threshold value and the drying threshold value in the converter slagging monitoring model. It is determined whether the comparison result indicates that the splashing or the drying will occur, the splashing information corresponding to the splashing or the drying information corresponding to the drying is acquired in a case that the comparison result indicates that the splashing or the drying will occur. Finally, the splashing control scheme is formulated based on the splashing information or the drying control scheme is formulated based on the drying information to guide subsequent slagging operations, thereby controlling a lance location steadily.

It can be seen that, in the present disclosure, it is avoided a defect that manual monitoring is limited by factors such as experiences and proficiency, thereby improving the stability and accuracy of the slagging state detection, and thus ensuring steady slagging to a high extent.

### Second Embodiment

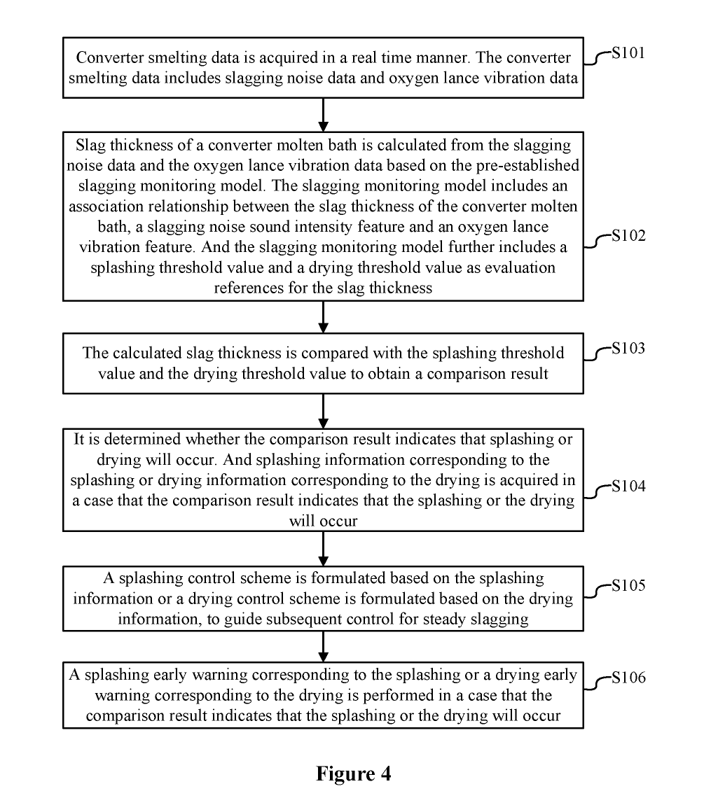

In the second embodiment, the method for monitoring converter slagging according to the first embodiment is optimized. Reference is made to FIG. 4, the method may further include step S106.

In step S106, a splashing early warning corresponding to the splashing or a drying early warning corresponding to the drying is performed in a case that the comparison result indicates that the splashing or the drying will occur.

In the embodiment, the early warning for the splashing or the drying is added. For example, the splashing early warning and the drying early warning are achieved by prompting with different sound. In this case, related persons may be notified to perform a steady control on the slagging, thereby avoiding the splashing or the drying.

### Third Embodiment

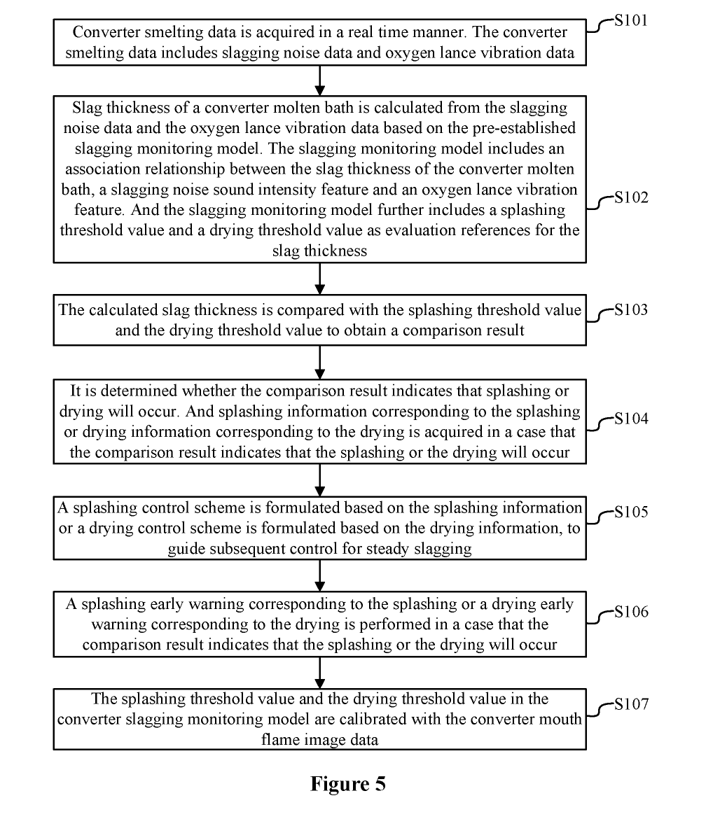

In the third embodiment, the method for monitoring converter slagging provided in the above is further optimized. In this embodiment, the acquired converter smelting data further includes converter mouth flame image data. In this case, the above method further includes step S107, as shown in FIG. 5.

In step S107, the splashing threshold value in the converter slagging monitoring model is calibrated with the converter mouth flame image data.

In order to ensure that the converter slagging monitoring model can reflect a slag thickness state accurately, the model has to be adjusted and calibrated dynamically. And the model is calibrated with converter mouth flame information in this embodiment.

It is appreciated by the applicant by research that, converter flame has different brightness features in beginning of smelting, middle of the smelting and ending of the smelting, and the brightness of the flame may be increased instantaneously when the splashing occurs. Therefore, an intensity level of the splashing may be calculated by analyzing the brightness feature of the flame image in a real time manner, and the splashing threshold value in the converter slagging monitoring model may be adjusted dynamically to improve accuracy of slagging state prediction.

In the embodiment, an image acquisition module is arranged at a corresponding location, from which real-time converter mouth flame information is acquired.

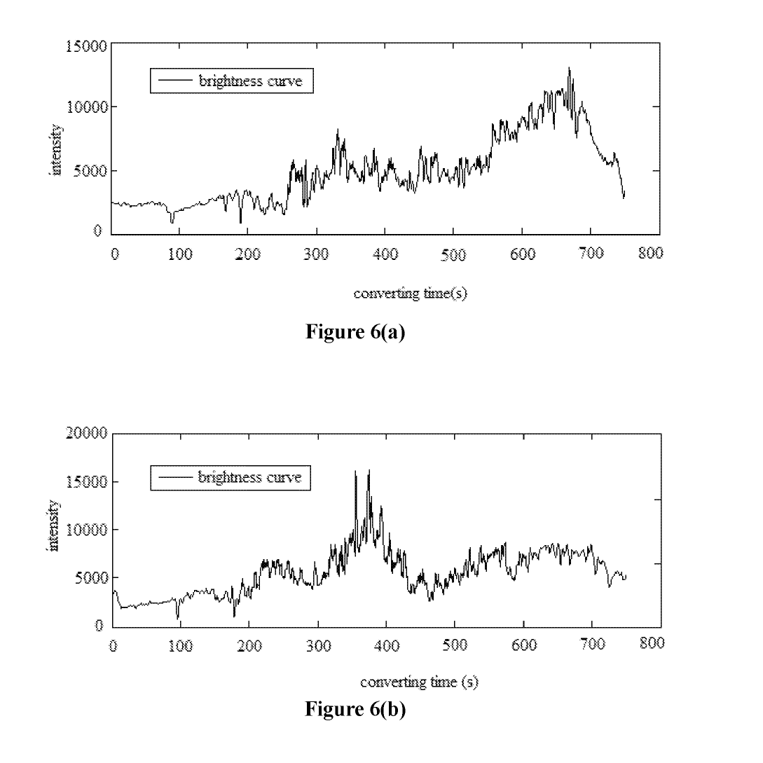

The applicant extracts beforehand a flame brightness feature in a case that the splashing occurs, and researches an association between the flame brightness feature and a slagging state by comparing the extracted feature with a flame brightness feature in a normal smelting at a corresponding time instant. FIG. 6(a) shows a flame brightness feature curve of a steady converting. It can be seen from FIG. 6(a) that, an intensity of the brightness is increased gradually in a converter smelting process, and the acquired feature curve falls sharply when approaching to end of the converter smelting process. This is consistent with a carbon-oxygen reaction rule in the different periods of the converting. In a heat shown in FIG. 6(b), the splashing occurs twice between 300 seconds and 400 seconds. It can be seen by comparing the curve shown in FIG. 6(b) with the curve shown in FIG. 6(a) that, the brightness feature of the heat shown in FIG. 6(b) is changed sharply and the brightness is increased instantaneously when the splashing occurs. In the embodiment, the heat and the number of times of the splashing occurring are labeled based on image analysis, and the association between the flame brightness feature and the slagging state is further researched based on the labeled data.

Based on the above, in a case that accuracy of the above model not meet a standard, the splashing threshold value in the above model is calibrated with the converter mouth flame information to ensure that the model has high accuracy.

In the embodiment, the converter slagging monitoring model is calibrated dynamically with the converter mouth flame information, thereby ensuring that the converter slagging monitoring model has high accuracy and thus improving accuracy of the splashing early warning.

### Fourth Embodiment

Process parameter data such as charging data, oxygen lance operation data, blown oxygen amount data and iron melt component data may affect the slag thickness during the converter smelting. Therefore, in the fourth embodiment, the process parameters during the converter smelting are introduced to the converter slagging monitoring model as reference data. In this case, the slagging state may be predicted based on the slagging noise feature, the oxygen lance vibration feature and the converter mouth flame image feature and in conjunction with the process parameters.

In the fourth embodiment, the converter slagging monitoring model is optimized with the process parameter data, thereby further improving the accuracy of the model in predicting the slagging state.

### Fifth Embodiment

The present disclosure provides a device for monitoring converter slagging corresponding to the method for monitoring converter slagging according to the above embodiments.

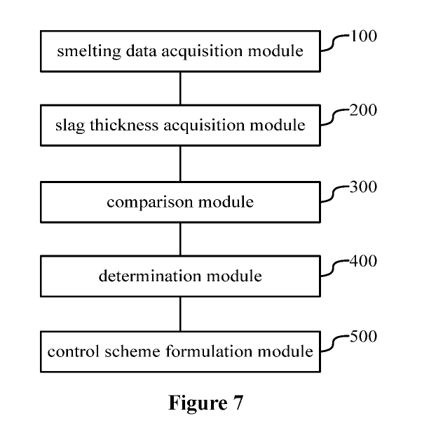

Reference is made to FIG. 7, corresponding to the first embodiment, the device for monitoring converter slagging includes a smelting data acquisition module 100, a slag thickness acquisition module 200, a comparison module 300, a determination module 400 and a control scheme formulation module 500.

The smelting data acquisition module 100 is configured to acquire converter smelting data in a real time manner, and the converter smelting data includes slagging noise data and oxygen lance vibration data.

The slag thickness calculation module 200 is configured to calculate slag thickness of a converter molten bath from the slagging noise data and the oxygen lance vibration data based on a pre-established converter slagging monitoring model. The converter slagging monitoring model includes an association relationship between the slag thickness of the converter molten bath, a slagging noise sound intensity feature and an oxygen lance vibration feature. And the converter slagging monitoring model further includes a splashing threshold value and a drying threshold value as evaluation references for the slag thickness.

The comparison module 300 is configured to compare the calculated slag thickness with the splashing threshold value and the drying threshold value to obtain a comparison result.

The determination module is configured to determine whether the comparison result indicates that splashing or drying will occur, and acquire splashing information corresponding to the splashing or drying information corresponding to the drying in a case that the comparison result indicates that the splashing or the drying will occur.

The control scheme formulation module is configured to formulate a splashing control scheme based on the splashing information or a drying control scheme based on the drying information, to guide subsequent control for steady slagging.

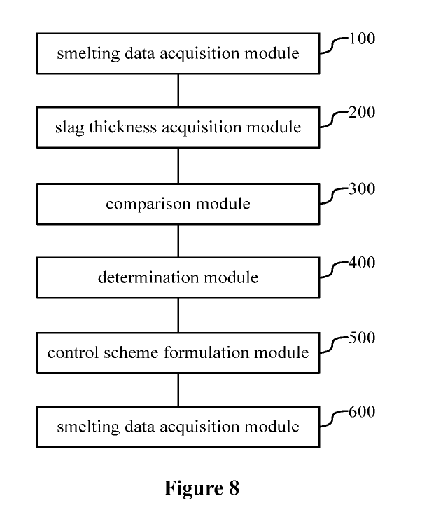

Corresponding to the second embodiment, as shown in FIG. 8, the above method further includes an early warning module 600 configured to perform a splashing early warning corresponding to the splashing or a drying early warning corresponding to the drying in a case that the comparison result indicates that the splashing or the drying will occur.

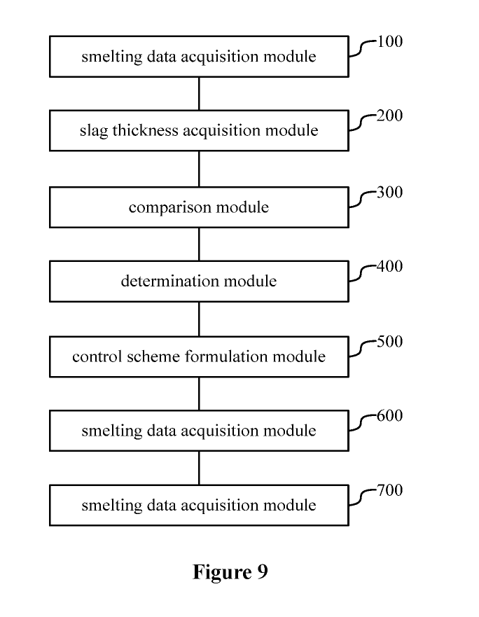

Corresponding to the third embodiment, as shown in FIG. 9, the above method further includes a model calibration module 700 configured to calibrate the splashing threshold value and the drying threshold value in the converter slagging monitoring model with acquired converter mouth flame image data.

The device for monitoring converter slagging according to the fifth embodiment of the present disclosure is described simply, since it corresponds to the method for monitoring converter slagging according to the above embodiments. Related and similar parts may refer to the description of the method for monitoring converter slagging according to the above embodiments, and are not described in detail herein.

Next, an application example of the method or system according to the present disclosure is described.

In the example, a slagging monitoring system based on the present disclosure is provided. The system includes a sound signal acquisition module, a vibration signal acquisition module, an image acquisition module, a data processing module and a control module.

A converter mouth noise acquisition module includes a high-sensitivity sound acquisition module, a multi-band audio analyzer and an intelligent purging module. The high-sensitivity sound acquisition module is configured to acquire a slagging noise signal in a converter slagging process. The multi-band audio analyzer may detect audio signals in four to eight feature frequency bands of the high-sensitivity sound acquisition module simultaneously, so that changes in sound frequency bands caused by changes in converter age and changes in converter lining, of different types of converters are fully covered. In this case, it is substantially addressed an issue that, a feature frequency band of the noise of a converter is changed due to a changed converter age and a changed converter lining and thus accuracy of an early warning is reduced after the converter is used for several months. The intelligent purging module is connected to the converter system in a real time manner and purges the high-sensitivity sound acquisition module after each heat of smelting and during each slag splashing, thereby effectively reducing maintenance strength of workers and improving reliability of the device.

The oxygen lance vibration signal acquisition module includes an acceleration sensor and a vibration signal analyzer. The acceleration sensor is configured to detect and acquire an oxygen lance vibration signal. Since the acceleration sensor is equipped with a portable mechanical protective device, it is avoided a deviation of the vibration signal caused by an installation mode of the sensor, and the service life of the sensor is prolonged. The vibration signal analyzer filters, amplifies and performs a frequency selection on the oxygen lance vibration signal detected by the acceleration sensor.

The flame image acquisition module includes a lens, a color CCD (Charge-Coupled Device) sensor and an image acquisition card. The lens is configured to capture a flame image. The color CCD sensor is configured to convert the flame image captured by the lens into digital image information by performing an analog to digital conversion on the flame image. The image acquisition card is configured to acquire the digital image information in the color CCD sensor and store the digital image information. The flame image acquisition module acquires and extracts the flame image in a real time manner. Brightness of the image may be transiently and suddenly changed in a case of the splashing. A level of the splashing intensity may be calculated from a size of the sudden change value. Data of a heat in which the splashing occurs is recorded and fed back to the converter slagging monitoring model to calibrate the splashing threshold value in the model.

The data processing module is configured to process the data acquired by the converter mouth noise acquisition module, the vibration signal acquisition module and the image acquisition module, and to predict the slag thickness inside the converter with the pre-established slagging monitoring model.

The control module, i.e. industrial control computer, is configured to centralizedly control the above modules, to make the modules coordinate with and cooperate with each another, to acquire and process various types of data and achieve slag thickness prediction.

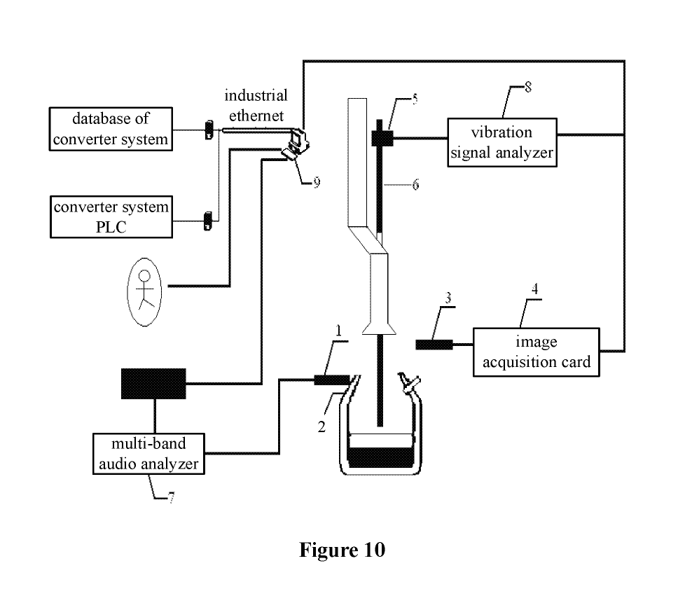

As shown in FIG. 10, the high-sensitivity sound acquisition module 1 in the device according to the example is mounted on a converter fire bulkhead 2. The CCD sensor 3 and the image acquisition card 4 included in the flame image acquisition module are mounted over a view window of a master control room. Two acceleration sensors 5 are respectively mounted on the oxygen lance A 6 and the oxygen lance B 6, (one of the two oxygen lances is in an operating state and the other is in a standby state, only one oxygen lance and one acceleration sensor are displayed in the figure). The multi-band audio analyzer 7, the vibration signal analyzer 8 and the industrial control computer 9 are mounted inside the master control room, and acquire a converter PLC (Programmable Logic Controller) signal and a converter database signal from the master control room.

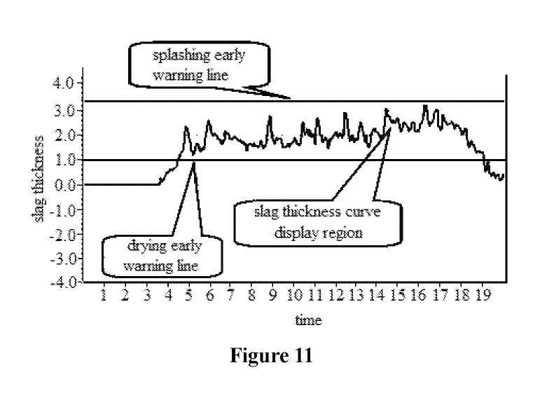

In the device according to the example, process parameter data in converter smelting, such as charging data, oxygen lance operation data, blown oxygen amount data and iron melt component data, is further introduced to the established slagging monitoring model as reference data. In this case, a slag thickness trend is predicted based on the established model and with the acquired slagging noise data, the oxygen lance vibration data, the process parameter data and the like. A curve of the slag thickness of a molten bath is rendered in a coordination space and is displayed on a display screen for skilled persons to view. And a splashing early warning line (corresponding to the splashing threshold value) and a drying early warning line (corresponding to the drying threshold value) are further rendered in the coordination space, as shown in FIG. 11. It can be seen from FIG. 11 that, the slag thickness trend curve is steady and does not cross the splashing early warning line and the drying early warning line, hence no splashing and drying occurs in a smelting process of a heat corresponding to FIG. 11.

It is already validated that, splashing reaction accuracy of the device in the example is greater than or equal to 90%, drying reaction accuracy of the device is greater than or equal to 95% and an early warning time is more than 10 seconds (that is, a prediction time is at least 10 seconds earlier than an actual occurring time). The sound intensity feature is adopted as a main impact factor for predicting the drying, and the early warning time is more than 15 seconds. The vibration feature is adopted as a main impact factor for predicting the splashing, the early warning time is more than 10 seconds. Hence the slagging operation can be guided effectively and the lance location is controlled steadily. Index numerical values corresponding to the above are shown in Table 1.

TABLE 1

| | Splashing reaction | Drying reaction | System |
|---|---|---|---|
| Operation indexes | accuracy | accuracy | response time |
| Index numerical | ≧90% | ≧95% | <1 second |
| values | | | |

Based on the above, in the present disclosure, the converter smelting noise signal, the oxygen lance vibration signal and the flame image information acquired in a real time manner are analyzed and processed based on the pre-established slagging monitoring model, thereby monitoring the slagging state in the converter in a real time manner and predicting the splashing and drying accurately and effectively. Compared with the existing manual monitoring mode which is limited by experiences and proficiency, in the method according to the present disclosure, stability and accuracy of a slagging state detection are improved, thereby ensuring steady slagging to a high extent.

It should be noted that, various embodiments in the specification are described in a progressive way, each embodiment lays emphasis on difference from other embodiments, and for the same or similar parts between various embodiments, one may refer to the description of other embodiments.

For simplicity in description, the above device is divided into modules or units based on functions, and is described by describing modules or units respectively. Of course, the functions of the modules and units may be achieved in one or more pieces of software and/or hardware in an implementation of the present application.

As can be seen from the descriptions of the above embodiments that, it should be apparent to those skilled in the art that the present application may be implemented by software and a necessary general-purpose hardware platform. Based on such understood, the technical solutions of the present application substantially or parts of the technical solutions contributing to the conventional technologies may be embodied by a software product. The computer software product may be stored in a storage medium such as ROM/RAM, magnetic disk and optical disk, and includes some instructions which enable a computer device (may be a personal computer, a server, a network equipment and the like) to perform the methods according to the embodiments or certain parts of the embodiments of the present disclosure.

Those described above are only preferred embodiments of the disclosure. It should be noted that, for those skilled in the art, improvements and modifications may also be made without departing from the principle of the disclosure. Those improvements and modifications should also be included in the protection scope of the disclosure.

1. A method for monitoring converter slagging, comprising:
acquiring converter smelting data in a real time manner, wherein the converter smelting data comprises slagging noise data and oxygen lance vibration data;
calculating slag thickness of a converter molten bath from the slagging noise data and the oxygen lance vibration data based on a pre-established converter slagging monitoring model, wherein the converter slagging monitoring model comprises an association relationship between the slag thickness of the converter molten bath, a slagging noise sound intensity feature and an oxygen lance vibration feature, and the converter slagging monitoring model further comprises a splashing threshold value and a drying threshold value as evaluation references for the slag thickness;
comparing the calculated slag thickness with the splashing threshold value and the drying threshold value to obtain a comparison result;
determining whether the comparison result indicates that splashing or drying will occur, and acquiring splashing information corresponding to the splashing or drying information corresponding to the drying in a case that the comparison result indicates that the splashing or the drying will occur; and
formulating a splashing control scheme based on the splashing information or a drying control scheme based on the drying information, to guide subsequent control for steady slagging.

2. The method according to claim 1, wherein the slagging noise data comprises an intensity of a slagging noise and a frequency band to which the slagging noise belongs, the oxygen lance vibration data comprises a frequency of oxygen lance vibration and an intensity of the oxygen lance vibration.

3. The method according to claim 1, further comprising:
performing a splashing early warning corresponding to the splashing or a drying early warning corresponding to the drying in a case that the comparison result indicates that the splashing or the drying will occur.

4. The method according to claim 1, wherein the converter smelting data further comprises converter mouth flame image data.

5. The method according to claim 4, further comprising: calibrating the splashing threshold value in the converter slagging monitoring model with the converter mouth flame image data.

6. The method according to claim 1, wherein the converter slagging monitoring model further comprises an association relationship between process parameter data during converter smelting and the slag thickness, the process parameter data comprises charging data, oxygen lance operation data, an amount of blown oxygen and an iron melt component.

7. A device for monitoring converter slagging, comprising: a smelting data acquisition module, a slag thickness acquisition module, a comparison module, a determination module and a control scheme formulation module, wherein
the smelting data acquisition module is configured to acquire converter smelting data in a real time manner, and the converter smelting data comprises slagging noise data and oxygen lance vibration data;
the slag thickness acquisition module is configured to calculate slag thickness of a converter molten bath from the slagging noise data and the oxygen lance vibration data based on a pre-established converter slagging monitoring model, the converter slagging monitoring model comprises an association relationship between the slag thickness of the converter molten bath, a slagging noise sound intensity feature and an oxygen lance vibration feature, and the converter slagging monitoring model further comprises a splashing threshold value and a drying threshold value as evaluation references for the slag thickness;
the comparison module is configured to compare the calculated slag thickness with the splashing threshold value and the drying threshold value to obtain a comparison result;
the determination module is configured to determine whether the comparison result indicates that splashing or drying will occur, and acquire splashing information corresponding to the splashing or drying information corresponding to the drying in a case that the comparison result indicates that the splashing or the drying will occur; and
the control scheme formulation module is configured to formulate a splashing control scheme based on the splashing information or a drying control scheme based on the drying information, to guide subsequent control for steady slagging.

8. The device according to claim 7, further comprising:
an early warning module configured to perform a splashing early warning corresponding to the splashing or a drying early warning corresponding to the drying in a case that the comparison result indicates that the splashing or the drying will occur.

9. The device according to claim 7, further comprising:
a model calibration module configured to calibrate the splashing threshold value in the converter slagging monitoring model with acquired converter mouth flame image data.
